(19) United States
(12) Patent Application Publication
(10) Pub. No.: US 2008/0120671 A1
(43) Pub. Date: May 22, 2008

(54) METHOD AND SYSTEM FOR SPEEDING UP CHANNEL CHANGE IN INTERNET PROTOCOL TELEVISION SERVICE AND DIGITAL BROADCASTING ENVIRONMENT

(76) Inventors: Jaecheol SIM, Daejeon-city (KR); Kee Seong CHO, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/872,198

(22) Filed: Oct. 15, 2007

(30) Foreign Application Priority Data
Nov. 16, 2006 (KR) 10-2006-0113478

(51) Int. Cl. H04N 7/173

(52) U.S. Cl. 725/116

(57) ABSTRACT

A method and system for speeding up channel change in an Internet protocol television (IPTV) service and digital broadcast service are provided. The system includes an extractor extracting a program association table (PAT) and a program map table (PMT), which include information for identifying elementary streams (ES) of a channel in a motion picture experts group-transport stream (MPEG-TS), and an output unit identifying elementary streams for the user-requested channel, in a MPEG-TS based on the PAT and the PMT transmitted from the extractor until the PAT and PMT in the received MPEG-TS are available, and outputting the decoded video and/or audio.

### CROSS-REFERENCE TO RELATED PATENT APPLICATIONS

This application claims the benefit of Korean Patent Application No. 10-2006-0113478, filed on Nov. 16, 2006, in the Korean Intellectual Property Office, the disclosure of which is incorporated herein in its entirety by reference.

### BACKGROUND OF THE INVENTION

1. Field of the Invention

The present invention relates to a method and system for speeding up channel change, and more particularly, to a method and system for providing a changed channel to users with reduced delay in an Internet protocol television (IPTV) service and a digital broadcasting environment when a change of broadcast channel is requested.

This work was supported by the IT R&D program of MIC/IITA.[2006-S058-01, Development of Network/Service Control Technology in AII-IP based Converged network]

2. Description of the Related Art

Generally, digital broadcasting transmits broadcast data according to a motion picture experts group-transport stream (MPEG-TS), which is an MPEG transmission standard. The MPEG-TS is delivered to a set-top box through various broadcast delivery networks, such as a terrestrial, a satellite, or a cable TV network. At this time, a plurality of audio, video, and data streams is multiplexed into a single MPEG-TS before being transmitted, so that a plurality of broadcast channels can exist in a single MPEG-TS.

Therefore, in order to find an elementary stream (ES), which is an individual stream such as audio, video or data, tables such as a program association table (PAT) and a program map table (PMT) are periodically inserted into an MPEG2-TS and then transmitted. Such tables and individual ESs are packetized with different packet IDs (PIDs), respectively. In addition, program and system information (PSI) such as a master guide table (MGT), a virtual channel table (VCT), and a rating region table (RPT), which respectively indicate a program guide, channel configuration information, and an audition rating, is inserted into the MPEG2-TS.

Information on PAT and PMT is required for decoding the MPEG-TS. Also, the MPEG-TS is a series of packets, which have different PIDs, respectively, and have different types of information according to those PIDs. In order to determine the audio or video stream in the MPEG-TS, the set-top box identifies firstly a PAT, which is a packet having PID 0. Next, the PID of a PMT recorded in the PAT is identified. The PID of the audio or the video stream can be determined only after the PMT packet is identified using the PMT PID, and then the audio or video stream can be identified so that video or audio output becomes available for decoding. Only the PID of the PAT is informed in advance, and therefore the audio/video stream cannot be processed until both of the PAT and the PMT are sequentially identified.

However, when these tables are transmitted frequently, the bandwidth of a broadcast stream is increased, and the workload for analyzing these tables is increased in a set-top box. For this reason, minimum transmission intervals for these tables are prescribed. It is preferable that the PAT and the PMT be transmitted at intervals of less than 100 ms and 400 ms, respectively, in the terrestrial broadcast service in Korea.

In the case of turning a TV on or changing a channel, MPEG-TS data can only be decoded with respect to a PAT and a PMT, thus audio/video information of an MPEG2-TS can be normally decoded after a delay of 400 ms or 500 ms.

Also, the video information included in the MPEG-TS is compressed for effective transmission. In the MPEG, each video frame_is classified into I-, B-, and P-frames, which are coded with different data compression methods. Only the I-frame is used to compress a frame as a still image, and the other B- and P-frames are encoded with only differences between frames. Therefore, in the case of initial decoding or channel changing, the set-top box needs to receive the I-frame in order to display a picture properly. However, because the B- and P-frames have a greater compression ratio than the I-frame, the least number possible of I-frames are usually used. And also, the decoder uses a jitter buffer, which stores a certain amount of data before decoding is performed in order to prevent losing data caused by a difference in transmission delay. In other words, even if the stream is received, it is displayed after a certain amount of data is stored.

It takes more time to display a newly selected channel in a digital broadcast system including an IPTV than in an analog broadcast system when a user changes TV channel in the middle of a program, due to the processes of extracting tables like PAT and PMT, receiving an I-frame, and sufficient jitter buffering. Normally, the speed of channel changing in an IPTV or a digital broadcast is usually about 1 to 2 seconds. Users, who choose a channel by repeatedly changing channels with a remote control, may feel uncomfortable and get annoyed about the delay in channel changing. There has been a lot of research on reducing the delay in channel changing.

Conventional methods are classified into four types.

In the first type of method, the data of a requested channel is received as soon as possible by reducing signaling delay as much as possible in a network during channel changing. In this case, the channel change time is decreased overall, but there is a problem in that the time taken to perform the operations of table identification, jitter buffering, and receiving of I-frames, which is the original limitation of the MPEG-TS, cannot be reduced.

In the second type of method, a large amount of data is sent by instantaneously increasing transmission speed so that the data can be received as soon as possible during channel changing. This method is applicable as part of a service, in which a server and a set-top box have a one-to-one connection like video on demand (VoD) service. However there is a problem that this method cannot be used when the data is transmitted using multicast technology like IPTV.

In the third type of method, previous broadcast data is stored in a network and, when the channel is changed, current data is sent after the previous data is sent rapidly. In this method, routers sending IPTV data shall store a predetermined amount of data of every channel. Existing routers do not have these functions. Moreover, when the number of broadcast channels increases, the required resources in a router are increased.

In the fourth type of method, that the set-top box predicts the next channel in advance. This method works on the assumption that users change channel with some pattern. For example, the next channel is predictable when the user changes channel in an up or down regular sequence. But the method is not effective when the user has the edited channel preference or inputs a channel number directly.

### SUMMARY OF THE INVENTION

The present invention provides a system and a method for speeding up broadcast channel change, in which information required to decode a motion picture experts group-transport stream (MPEG-TS) is transmitted to a set-top box as early as possible through the Internet so that the set-top box can rapidly display the changed channel, thereby reducing delay in displaying during the channel change.

According to an aspect of the present invention, there is provided a system for speeding up broadcast channel change in the Internet protocol television (IPTV) service or in the digital broadcast environment.

The system includes a broadcast station transmitting a motion picture experts group-transport stream (MPEG-TS); an extractor receiving the MPEG-TS from the broadcast station and extracting and maintaining a program association table (PAT) and a program map table (PMT), which comprise information for identifying elementary streams (ES) of a channel in the MPEG-TS and transmitting the extracted PAT and PMT; and an output unit receiving the MPEG-TS from the broadcast station and the extracted PAT and PMT from the extractor and decoding elementary streams (ES) in the MPEG-TS for a channel, which is requested by a user to change using the received PAT and PMT, and outputting the video and audio

According to another aspect of the present invention, there is provided a method of speeding up broadcast channel change in the IPTV service or in the digital broadcast environment. The method includes extracting a PAT and a PMT, which comprise information for identifying elementary streams of a channel in a MPEG-TS, which received from a broadcast station; transmitting the extracted PAT and PMT to a user's terminal when the user requests channel to change or before the user's channel change request; and decoding ES for a channel requested by the user to change in the MPEG-TS using the PAT and PMT, which are transmitted to the user's terminal, and outputting video and/or audio in the user's terminal.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram of a system for speeding up broadcast channel change according to an embodiment of the present invention;

FIG. 2 illustrates a system for speeding up broadcast channel change in the Internet protocol television (IPTV) service according to an embodiment of the present invention;

FIG. 3 illustrates a system for speeding up broadcast channel change in the digital broadcast environment according to an embodiment of the present invention;

FIG. 4 illustrates the configuration of the motion picture experts group-transport stream (MPEG-TS), according to an embodiment of the present invention;

FIG. 5 is a flowchart of the operations of a set-top box when a PAT and a PMT for a requested channel are transmitted to the set-top box, according to an embodiment of the present invention;

FIG. 6 is a flowchart of the operations of the set-top box when the latest PAT and PMT for all channels are transmitted to the set-top box, according to an embodiment of the present invention; and

FIG. 7 is a flowchart of the operations of the set-top box when the PAT and PMT for all channels are pre-scheduled and transmitted to the set-top box, according to an embodiment of the present invention.

### DETAILED DESCRIPTION OF THE INVENTION

Hereinafter, preferred embodiments of the present invention will be described in detail with reference to the attached drawings. In the drawings, the same reference numeral denotes the same element.

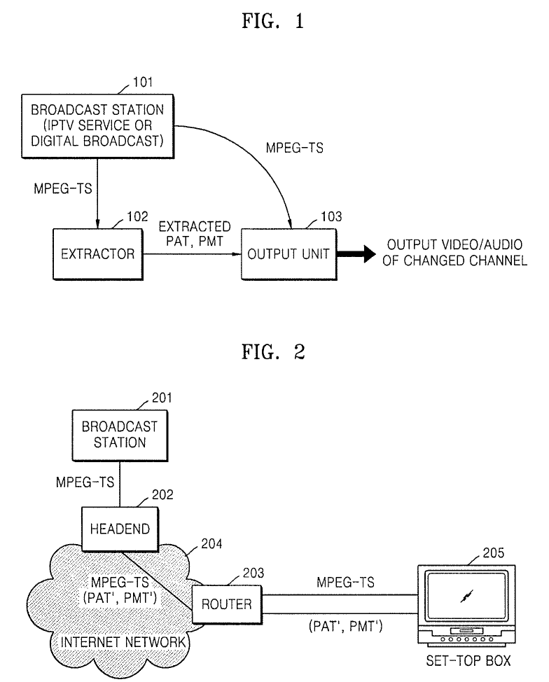

FIG. 1 is a diagram of a system for speeding up broadcast channel change according to an embodiment of the present invention.

A broadcast station 101 broadcasts a motion picture experts group transport stream (MPEG-TS), which provides a TV channel or multiple TV channels for the Internet protocol television (IPTV) service or the digital broadcast service. The extractor 102 extracts program association table (PAT) information and program map table (PMT) information, which is used to identify elementary streams (ES) for a channel from the MPEG-TS. The extractor 102 may exist in a broadcast head-end or in an Internet router. The extractor 102 receives the MPEG-TS from the broadcast station 101 and extracts a PAT and PMT from the received MPEG-TS. The extractor 102 maintains the latest PAT and PMT according to updates of PAT and PMT in the MPEG-TS. The PAT and PMT extracted by the extractor 102 are transmitted to an output unit 103.

The output unit 103 identifies the elementary streams of the requested channel in the MPEG-TS, which is received from the broadcast station 101, with the PAT and PMT received from the extractor 102 until the PAT and PMT in the received MPEG-TS are available and then outputs the identified audio and video elementary streams to the user.

As such, since the output unit 103 does not need to wait for the PAT and the PMT in the MPEG-TS are available, delay for identifying elementary streams is reduced, and therefore, the changed channel can be more rapidly shown to the user. Thereafter, the output unit 103 extracts the PAT and the PMT from the MPEG-TS during the initial decoding using the PAT and PMT received from the extractor 102. The output unit 103 decodes the MPEG-TS based on the extracted PAT and PMT and outputs video and/or audio. In other words, until the PAT and PMT in MPEG-TS are extracted by the output unit 103, the output unit 103 uses the PAT and PMT received from the extractor 102 to identify elementary streams (ES). Once the PAT and PMT in MPEG-TS are extracted by the output unit 103, the output unit 103 uses the extracted PAT and PMT to identify elementary streams.

FIG. 2 illustrates a system for speeding up broadcast channel change in an IPTV service according to an embodiment of the present invention.

The IPTV service is different from a terrestrial broadcast, satellite broadcast, and cable broadcast in that the IPTV is provided through an Internet network 204 based on an IP network. However, since the broadcast station 201 produces and transmits a broadcast program encapsulated in MPEG-TS, the MPEG-TS received from the broadcast station 201 is packetized into IP packets on the headend 202 for delivery through the Internet.

In the IPTV network, only a currently selected channel is transmitted to a set-top box, unlike in satellite, terrestrial and cable digital TV in which every channel is transmitted to a set-top box and the set-top box selects and decodes a channel. Accordingly, the IPTV requires an additional procedure with which the set-top box requests the selected channel to the network and the network transmits MPEG-TS in response to the request.

In the current embodiment, the MPEG-TS is received from the broadcast station 201 to the headend 202, which exists in the Internet network 204. The MPEG2-TS received in the headend 202 is packetized and streamed to an IPTV set-top box 205 through a router 203 in the Internet network 204. At this moment the headend 202 may reproduce the MPEG-TS with codec conversion or repackaging of constituting channels of the received MPEG-TS. The router 203 or the headend 202, which exist in the Internet 204, searches only a PAT and a PMT from the MPEG-TS, which is received in real time, in order to maintain the latest PAT and PMT.

During the selection of a broadcast channel, the set-top box 205 request the selected channel to the router 203 or the headend 202 in the Internet network 204. Once the requested channel is authorized, the Internet network 204 sends the MPEG-TS for the requested channel to the set-top box 205.

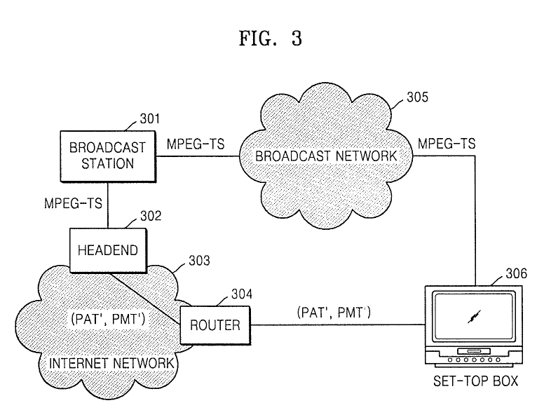

FIG. 3 illustrates a system for speeding up broadcast channel change in the digital broadcast environment according to an embodiment of the present invention.

In terrestrial, satellite, and cable broadcast networks, a broadcast station 301 transmits a MPEG-TS to a set-top box 306 through the broadcast network 305 and also transmits the MPEG-TS to a headend 302, which exists in the Internet 303. The router 302 or the headend 304, which exists in the Internet network 303, searches for only a PAT and PMT from the received MPEG-TS in real time in order to maintain the latest PAT and PMT.

The set-top box 306 transmits a channel request to the router 304 or the headend 302 in the Internet network 303.

The channel request in the IPTV network and other broadcast networks may be performed using various protocols, such as IGMP, SIP, and RTSP according to the configuration of the IPTV service network. Such a channel request using those protocols is well known to those of ordinary skill in the art and therefore a detailed description thereof will be omitted.

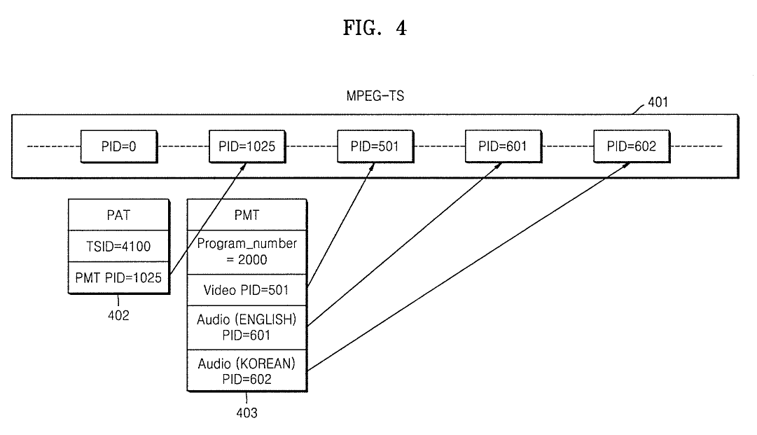

FIG. 4 illustrates the configuration of an MPEG-TS 401 according to an embodiment of the present invention.

Referring to FIG. 4, the MPEG-TS 401 includes a plurality of packets, each of which has a packet identification (PID). The PAT 402 has the predefined PID, 0. The PMT 403 has PID value 1025, which is indicated in PAT. And the PMT 403 indicates that a program of program_number 2000 has three elementary streams, a video, a audio(English) and a audio(Korean), respectively having PID value of 501, 601,602.

In the present invention, the extractor 102 or the headend 202, 302 extracts the PAT and PMT from the MPEG-TS received from the broadcast station and the extracted PAT and PMT are sent to the output unit 103 or the set-top box 205, 306 additionally with the MPEG-TS.

Hereinafter, the extracted PAT and PMT are represented by PAT′ and PMT′. The headend and router maintains the most updated PAT′ and PMT′ for each channel, and when a channel request is received from an IPTV set-top box, transmits the PAT′ and the PMT′ preferentially and then transmits the MPEG-TS 401. Although the PAT′ and the PMT′ may be reformatted into a special format so as to be suitable for Internet transmission, the set-top box can process the MPEG-TS with PAT′ and PMT′.

There are three main methods by which a service network (i.e., a headend and router) sends the PAT′ and the PMT′ to a set-top box.

Firstly, when the set-top box changes a channel, the PAT′ and the PMT′ for the requested channel are sent from the service network. In this method, the PAT′ and the PMT′ are transmitted in response to the channel request. PAT′ and PMT′ may be piggy-backed on a reply message of the network responding to a channel request message or may be sent in a separate message. This method is suitable for a service such as IPTV, in which a MPEG-TS is sent in response to a request for a channel.

Secondly, the latest PAT′ and PMT′ for every available channel are sent to the set-top box in a bundle, and the set-top box maintains the received PAT′ and PMT′ for all channels but uses only a PAT′ and PMT′ for the selected channel to decode the received MPEG-TS. In this method the service network send the PAT′ and PMT′ periodically or on update of PAT′ or PMT′.

The third method is a modification of the second method. When the values of a PAT and a PMT for every channel are predictable based on, for example, a broadcast schedule, a scheduled PAT′ and PMT′ for every channel for a predefined duration, are sent as a form of a time table to the set-top box in advance of the request from the set-top box.

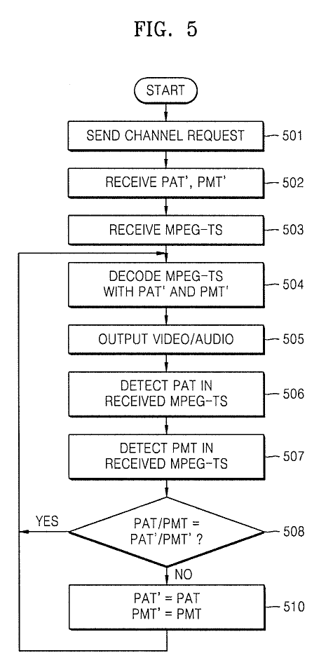

The three methods will be described in detail with reference to FIGS. 5 through 7.

FIG. 5 is a flowchart of the operations of a set-top box when a PAT and a PMT of a requested channel are transmitted to the set-top box, according to an embodiment of the present invention.

In operation 501, the set-top box sends a user's channel request to a network. The set-top box receives a PAT′ PMT′ from the network in operation 502 and receives an MPEG-TS in operation 503. The set-top box does not search the PAT and the PMT, which are embedded in the received MPEG-TS, but instead decodes the received MPEG-TS using the PAT′ and the PMT′ in operation 504 and outputs a decoded video/audio in operation 505.

The PAT and the PMT are detected in the received MPEG-TS in operations 506 and 507. The PAT and the PMT are respectively compared with the PAT′ and the PMT′ in operation 508. If the PAT or PMT is different from the PAT′ or PMT′, the PAT′ or PMT′ is updated with the PAT or PMT respectively in operation 509 and then the MPEG-TS is decoded with the updated PAT′ and PMT′ hereafter.

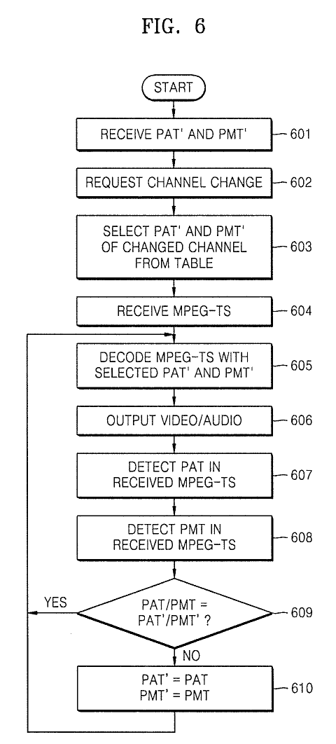

FIG. 6 is a flowchart of the operations of the set-top box when the latest PAT and PMT for all channels are transmitted to the set-top box, according to an embodiment of the present invention.

The latest PAT′ and PMT′ for every available channel are sent to the set-top box in a bundle, and the set-top box maintains the received PAT′ and PMT′ for all channels but uses only a PAT′ and PMT′ for the selected channel to decode the received MPEG-TS. When the PAT′ and the PMT′ for every channel are transmitted, the PAT′ and the PMT′ only need to be transmitted periodically or on update of PAT′ or PMT′. In this case, a headend or a router in a service network updates the PAT′ and the PMT′ on change of the PAT and the PMT in the MPEG-TS, regardless of a channel request from the set-top box, and transmits the latest PAT′ and PMT′ to the set-top box.

In operation 601, the set-top box receives the PAT′ and the PMT′ for every channel in a form of a table. When a user changes a channel in operation 602, the set-top box selects the PAT′ and the PMT′ of the changed channel from the received table in operation 603 and receives the MPEG-TS in operation 604.

The set-top box does not search the PAT and the PMT in the received MPEG-TS but decodes the received MPEG-TS with the selected PAT′ and PMT′ in operation 605 and outputs a decoded video and/or audio in operation 606.

The PAT and the PMT are detected in the received MPEG-TS in operations 607 and 608. The PAT and the PMT are respectively compared with the PAT′ and the PMT′ in operation 609. If the PAT or PMT is different from the PAT′ or PMT′, the PAT′ or PMT′ is updated with the PAT or PMT respectively in operation 610 and then the MPEG-TS is decoded with the updated PAT′ and PMT′ hereafter.

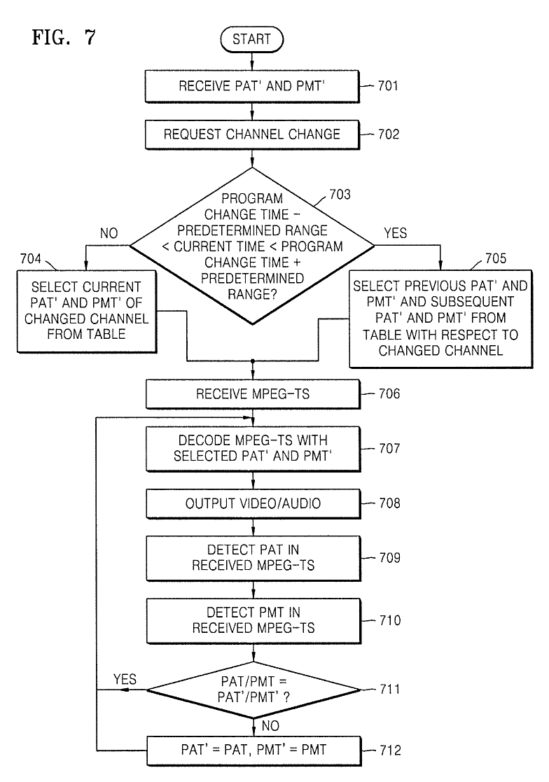

FIG. 7 is a flowchart of the operations of the set-top box when the PAT and PMT for all channels are pre-scheduled and transmitted to the set-top box, according to an embodiment of the present invention.

The method illustrated in FIG. 7 is a modification of the method illustrated in FIG. 6. The method illustrated in FIG. 7 is used when the values of a PAT and a PMT for every channel are predictable based on, for example, a broadcast schedule. A network sends to the set-top box a PAT and a PMT of every channel for a predefined duration, as a form of a time table in advance of the request from the set-top box in operation 701. When a user changes a channel in operation 702, the set-top box selects a PAT′ and a PMT′ from the received tables according to a current time and the changed channel and decodes an MPEG-TS with the selected PAT′ and PMT′ in operation 703. At this time, since the set-top box has difficulty in maintaining an exact time, the set-top box determines whether the current time is within a predetermined range from the program changing time, which implies the time that the PAT and PMT are scheduled to be changed. If the current time is within the predefined range, it is a critical moment in which PAT and PMT values may be changed. Accordingly, the set-top box selects the PAT′ and PMT′ of a previous program and the PAT′ and PMT′ of a subsequent program based on the current time and the selected channel in operation 705. If the current time is not within the predetermined range, a PAT′ and PMT′, which correspond to the current time of the changed channel, are selected from the received tables in operation 704. In other words, when the user's channel change is requested within the predetermined range centering on the time when a currently broadcasted program is changed, the set-top box selects with both pair of the preceding PAT′ and PMT′ and the succeeding PAT′ and PMT′ for decoding the received MPEG-TS until the PAT and PMT from the received MPEG-TS is to be found.

Thereafter, the MPEG-TS is received in operation 706. The set-top box does not search the PAT and PMT in the MPEG-TS but instead decodes the MPEG-TS using the selected PAT′ and PMT′ in operation 707 and outputs a decoded video and/or audio in operation 708. The PAT and PMT are detected in the received MPEG-TS in operations 709 and 710. The PAT and PMT are respectively compared with the PAT′ and PMT′ in operation 711. If the PAT or PMT is different from the PAT′ or PMT′, the PAT′ or PMT′ is updated with the PAT or PMT respectively in operation 712 and then the MPEG-TS is decoded with the updated PAT′ and PMT′ hereafter.

In the second method described with FIG. 6, the PAT′ and the PMT′ are transmitted to the set-top box whenever they are changed, therefore the transmission processing load and the bandwidth increase. However, in the third method described with FIG. 7, the required bandwidth and transmission processing load may be reduced by appropriately setting a duration that the table describes. But, since a real broadcast does not exactly start or end at a scheduled time, the set-top box may not have accurate PAT and PMT values at the moment when the program is changed. In order to solve this problem, the set-top box decodes elementary streams on the assumption that either of two PATs and PMTs within a predefined range from the program change time may be the actual PAT and PMT. Thus, the set-top box tries to identify elementary streams with two PATs and PMTs, one PAT and PMT for before the program change and the other PAT and PMT for after the program change.

Program and system information (PSI) including a master guide table (MGT), a virtual channel table (VCT), and a rating region table (RRT) may be transmitted to the set-top box so as to be used as an auxiliary for finding a stream of a channel in an MPEG-TS, too. When the PSI such as the MGT, the VCT, and the RRT is sent together with the PAT and the PMT, entire channel configuration and rating information can be quickly detected so that service can be efficiently provided during channel changing. The PSI is defined to be transmitted at intervals of one minute by the most standards.

According to the present invention, as well as an existing MPEG-TS, PAT and PMT information is extracted in real time from an MPEG-TS, which is sent from a broadcast station, and the PAT and PMT are provided separately to the set-top box, so that the decoding delay of channel changing can be reduced in an IPTV or digital broadcast service.

While the present invention has been particularly shown and described with reference to exemplary embodiments thereof, it will be understood by those of ordinary skill in the art that various changes in form and details may be made therein without departing from the spirit and scope of the present invention as defined by the appended claims.

What is claimed is:

1. A system for speeding up broadcast channel change in an Internet protocol television (IPTV) service or in a digital broadcast environment, the system comprising:
a broadcast station transmitting a motion picture experts group-transport stream (MPEG-TS);
an extractor receiving the MPEG-TS from the broadcast station and extracting and maintaining a program association table (PAT) and a program map table (PMT), which comprise information for identifying elementary streams (ES) of a channel in the MPEG-TS and transmitting the extracted PAT and PMT; and
an output unit receiving the MPEG-TS from the broadcast station and the extracted PAT and PMT from the extractor and decoding elementary streams (ES) in the MPEG-TS for a channel, which is requested by a user to change using the received PAT and PMT, and outputting the video and audio.

2. The system of claim 1, wherein the extractor exists in a broadcast headend or an Internet router.

3. The system of claim 1, wherein the extractor transmitting the MPEG-TS, the extracted PAT and PMT to the output unit through an Internet in the IPTV service;
The output unit receives the MPEG-TS, the extracted PAT and PMT from the extractor.

4. The system of claim 1, wherein the extracted PAT and PMT are for all available channels in the MPEG-TS.

5. The system of claim 1, wherein the extracted PAT and PMT are for every channel in the MPEG-TS for a predefined duration.

6. The system of claim 5, wherein, when the user requests the channel to change within a predefined time range from the time when a current broadcast program is changed, the output unit tries to identify the streams for the requested channel using two PATs and PMTs, one for before the program is changed and the other for after the program is changed and outputs the video and/or audio.

7. The system of claim 1, wherein, when the user requests the channel to change, the extractor transmitting program and system information (PSI) including at least one of a master guide table (MGT), a virtual channel table (VCT), and a rating region table (RRT), which will be used as an auxiliary for finding the stream of the channel in the MPEG-TS.

8. The system of claim 1, wherein the broadcast station transmits the MPEG-TS through an Internet in the IPTV service and transmits through a digital broadcast network in a digital broadcast environment.

9. The system of claim 1, wherein, after the initial decoding using the received PAT and PMT, the output unit extracts a new PAT and PMT from the MPEG-TS, finds ES of the channel in the MPEG-TS based on the new PAT and PMT, and outputs the video and/or audio.

10. A method of speeding up broadcast channel change in an Internet protocol television (IPTV) service or in a digital broadcast environment, the method comprising:
(a) extracting a program association table (PAT) and a program map table (PMT), which comprise information for identifying elementary streams of a channel in a motion picture experts group-transport stream (MPEG-TS), which received from a broadcast station;
(b) transmitting the extracted PAT and PMT to a user's terminal when the user requests channel to change or before the user's channel change request; and
(c) decoding elementary streams (ES) for a channel requested by the user to change in the MPEG-TS using the PAT and PMT, which are transmitted to the user's terminal, and outputting video and/or audio in the user's terminal.

11. The method of claim 10, wherein operation (a) comprises updating the latest PAT and PMT values according to the MPEG-TS.

12. The method of claim 10, wherein operation (b) comprises transmitting the MPEG-TS, the extracted PAT and PMT to the user's terminal through an Internet in the IPTV service.

13. The method of claim 10, wherein the extracted PAT and PMT are for all available channels in the MPEG-TS.

14. The method of claim 10, wherein the extracted PAT and PMT are for every channel in the MPEG-TS for a predefined duration.

15. The method of claim 14, wherein, when the user requests the channel to change within a predefined time range from the time when a current broadcast program is changed, operation (c) comprises tries to identify the streams for the requested channel using two PATs and PMTs, one for before the program is changed and the other for after the program is changed and outputs the video and/or audio.

16. The method of claim 10, wherein when the user requests the channel to change, operation (b) comprises transmitting program and system information (PSI) including at least one of a master guide table (MGT), a virtual channel table (VCT), and a rating region table (RRT), which will be used as an auxiliary for finding the stream of the channel in the MPEG-TS, to the user's terminal.

17. The method of claim 10, wherein the MPEG-TS is transmitted through an Internet in the IPTV service and is transmitted through a digital broadcast network in the digital broadcast environment from the broadcast station.

18. The method of claim 10, wherein operation (c) comprises, after the initial decoding using the received PAT and PMT, extracting a new PAT and PMT from the MPEG-TS, decoding ES of the channel in the MPEG-TS based on the new PAT and PMT, and outputting the video and/or audio to the user's terminal.
